(19) United States
(12) Patent Application Publication
(10) Pub. No.: US 2017/0282515 A1
(43) Pub. Date: Oct. 5, 2017

(54) Heat-Sealable Film and Lusterless Film Having Low-Heat Sealing Property Comprising the Same

(71) Applicant: SK Innovation Co., Ltd., Seoul (KR)

(72) Inventors: Kang Min Jung, Daejeon (KR); Yong Rak Moon, Daejeon (KR)

(21) Appl. No.: 15/478,707

(22) Filed: Apr. 4, 2017

(30) Foreign Application Priority Data
Apr. 5, 2016 (KR) 10-2016-0041636

(51) Int. Cl. B32B 27/32; B32B 27/08

(52) U.S. Cl. CPC B32B 27/32; B32B 27/08; B32B 2307/31; B32B 2307/40; B32B 2323/10; B32B 2323/04

(57) ABSTRACT

Provided are a heat-sealable film, and a lusterless film having a low-heat sealing property including the same. More specifically, provided are a heat-sealable film capable of sealing at a low temperature without any other defect to reduce processing costs and increase productivity, and a lusterless film having a low-heat sealing property including the same capable of implementing a high-quality and soft touch by reducing gloss of a film surface while having a low-heat sealing property.

### CROSS-REFERENCE TO RELATED APPLICATION

This application claims priority to Korean Patent Application No. 10-2016-0041636 filed Apr. 5, 2016, the disclosure of which is hereby incorporated in its entirety by reference.

### TECHNICAL FIELD

The following disclosure relates to a heat-sealable film, and a lusterless film having a low-heat sealing property including the same. More specifically, the following disclosure relates to a heat-sealable film capable of sealing at a low temperature without any other defect to reduce processing costs and increase productivity, and a lusterless film having a low-heat sealing property including the same capable of implementing a high-quality and soft touch by reducing gloss of a film surface while having a low-heat sealing property.

### BACKGROUND

In general, a method of laminating a film to a substrate such as paper, metal, film, or the like, includes a thermal lamination method in which an aqueous adhesive or an oily adhesive is applied to a stretched polypropylene film and then, they are bonded by melting a low-heat thermal adhesive resin, in addition to a dry lamination method in which an aqueous adhesive or an oily adhesive is applied to a stretched polypropylene film and then, they are bonded by passing through a drying device.

Polypropylene is widely used as a thermoplastic molding material having excellent properties such as rigidity, heat resistance, and transparency, etc. On the other hand, the polypropylene is usually blended with a soft rubber component because of insufficient flexibility and insufficient impact resistance. Even if the soft rubber component is blended to compensate for insufficient flexibility and insufficient impact resistance of the polypropylene, a polypropylene composition obtained by blending the soft rubber component with the polypropylene has a reduced heat resistance. In addition, the polypropylene composition is also required to have an improved low-temperature heat sealing property.

Meanwhile, crystalline polypropylene has excellent mechanical properties such as tensile strength, rigidity, surface hardness, impact strength resistance, etc., excellent optical properties such as glossiness, transparency, etc., or excellent food hygiene property such as non-toxicity, odorless property, etc. These properties are widely used especially in a food packaging field. However, a single-layer film made of this crystalline polypropylene shrinks at a heat sealing temperature, and thus, there is difficulty in heat sealing the film. Accordingly, the crystalline polypropylene film is usually provided with a heat sealing layer formed of polymers such as low-density polyethylene or propylene/ethylene random copolymer, etc.

The heat sealing layer formed of the polymer (1) should be subjected to heat sealing at a considerably lower temperature than that of a base film (crystalline polypropylene film), (2) should require a high heat sealing strength that hardly deteriorates over time, (3) should have excellent adhesion with the base film at the time of manufacturing a multilayer film, (4) should have transparency equal to or higher than that of the base film, (5) should not cause blocking during storage to improve workability, (6) should not be adhered to a jig of a bag-making device or a filling-packing device, (7) should have high shore hardness to have high scratch resistance, and (8) should not cause gel or fish-eye phenomenon at the time of a process of forming the film.

However, conventionally known heat sealing materials do not satisfy all these performances. For example, the low-density polyethylene is capable of being heat sealed at a low temperature, but has poor heat sealing strength, poor adhesion with a base film, low transparency, and is easily adhered to a packaging jig.

The propylene/ethylene random copolymer is capable of satisfying the above performances (2) to (7), but does not satisfy the performance (1). A polypropylene composite film including a heat sealing layer formed of the propylene/ethylene random copolymer has a narrow heat sealing temperature width. Therefore, when these composite films are heat sealed by an automatic packaging machine or by an automatic bag-making machine, it is required to precisely control the heat sealing temperature. Other materials proposed so far as the heat sealing material may include blends of the propylene/ethylene random copolymer and an ethylene/α-olefin copolymer. These blends have more improved low-temperature heat sealing property, but have lower transparency as compared to those of the propylene/ethylene random copolymer.

In addition, there is a currently growing interest in resins providing emotional feeling rather than plastics having cold feeling, and accordingly, the demand for a lusterless film capable of simultaneously expressing low gloss and smooth texture has become gradually increased.

In general, the lusterless film may diffuse external light, thereby reducing fatigue of eyes seen in a gloss film, preventing disclosure of a package object, and simultaneously providing a product an elegance. However, since the lusterless film used in the related art has a low-density of a lusterless surface, the film has a poor appearance and has a structure in which a composite resin composition is melted and extruded to be laminated on a substrate acting as a base, and thus, it is difficult to freely control a thickness of the lusterless film and manufacturing cost may be increased.

Therefore, a film satisfying a lusterless property while satisfying all the requirements of performances (1) to (7) is still required to be developed.

### RELATED ART DOCUMENT

(Patent Document 1) Japanese Laid-Open Publication No. 1996-238733 (Mar. 7, 1996)
(Patent Document 2) Korean Patent Laid-Open Publication No. 10-2012-0121711 (Nov. 6, 2012)

### SUMMARY

An embodiment of the present invention is directed to providing a heat-sealable film including a polyethylene-based resin and a polyolefin-based elastomer, wherein the polyolefin-based elastomer satisfies specific density, specific tensile strength, and specific melt index, in order to solve problems of conventional heating sealing films.

Further, another embodiment of the present invention is directed to providing a lusterless film capable of being subjected to low-temperature heat sealing by including a heat-sealable film, a center layer formed on one surface of the heat-sealable film and including a polypropylene-based resin, and a skin layer formed on one surface of the center layer and including a polypropylene-based resin, thereby having excellent lusterless effect, being sealed at a lower temperature than conventional lusterless films, and simultaneously implementing a low gloss and a smooth texture without causing fish eyes and gel, etc., and a manufacturing method thereof.

The present invention provides a heat-sealable film, a lusterless film having a low-heat sealing property using the heat-sealable film, and a manufacturing method thereof.

In one general aspect, a heat-sealable film includes: 10 to 90 wt % of a polyethylene-based resin, and 10 to 90 wt % of a polyolefin-based elastomer.

In another general aspect, a lusterless film having low-heat sealing property includes: the heat-sealable film as described above; a center layer formed on one surface of the heat-sealable film and including a polypropylene-based resin; and a skin layer formed on one surface of the center layer and including a polypropylene-based resin.

The above-described exemplary embodiments are not limited to the description of the present invention, and include all matters that may be easily modified by those skilled in the art. As an example, other forms of devices may be used with the purpose of practicing the same technique.

### DETAILED DESCRIPTION OF EMBODIMENTS

Hereinafter, a heat-sealable film, a lusterless film having low-heat sealing property by using the same, and a manufacturing method thereof according to the present invention are described in detail with reference to specific exemplary embodiments. The specific exemplary embodiments of the present invention to be described below are provided by way of example so that the idea of the present invention is able to be sufficiently transferred to those skilled in the art to which the present invention pertains. Therefore, the present invention may be implemented in different forms, without being limited to the specific exemplary embodiments to be described below.

Terms used herein are used to describe particular aspects (or Examples) only and thus, it is not intended to limit the present invention. The singular forms are intended to include the plural forms as well, unless the context clearly indicates otherwise. It will be further understood that the terms “may include”, “may be formed of”, etc., used in this specification, specify the presence of features, figures, steps, operations, components, parts, or a combination thereof described in the specification, but do not preclude possibility of presence or addition of one or more other features, numerals, steps, operations, components, parts, or a combination thereof.

Further, unless technical and scientific terms used herein are defined otherwise, they have meanings generally understood by those skilled in the art to which the present invention pertains. Known functions and configurations that may unnecessarily obscure the gist of the present invention will be omitted.

A term ‘polymer’ as used in the present invention may include a homopolymer, a copolymer, an interpolymer, a terpolymer, etc.

A term ‘elastomer’ or ‘elastomeric composition’ as used in the present invention may include any polymer or composition of polymers (for example, blend of polymers) which is consistent with the definition of ASTM D1566. In addition, the elastomer may also include a blend of polymers, such as melt mixing of polymers and/or a blend with a reactor.

Term ‘copolymer’ as used in the present invention may include a polymer formed by polymerization of two or more different monomers, unless otherwise specified.

The heat-sealable film according to the present invention may include: 10 to 90 wt % of a polyethylene-based resin; and 10 to 90 wt % of a polyolefin-based elastomer.

In the present invention, the polyethylene-based resin is not limited to the type as long as it is applied to various fields such as a film, etc., but preferably includes high-density polyethylene (HDPE).

In the present invention, the polyethylene-based resin may be included in a content of 10 to 90 wt %, and more preferably 30 to 70 wt % based on 100 wt % of the total heat-sealable film composition. When the polyethylene-based resin is included in a content of less than 10 wt % or more than 90 wt %, the content of the polyethylene-based resin in the total film composition may be relatively small or large, and thus, a lusterless effect of the film may be reduced.

In the present invention, the polyolefin-based elastomer includes an elastomer or a plastomer including olefin units generally known in the art, and may be a copolymer or a terpolymer including propylene-derived units and at least one or more units of ethylene or alpha-olefin. In addition, the polyolefin-based elastomer generally does not have any substantial intermolecular heterogeneity in tacticity and comonomer composition, and further, it is preferred that the polyolefin-based elastomer generally does not have any substantial heterogeneity in intramolecular composition distribution.

In the present invention, the polyolefin-based elastomer includes ethylene, 1-butene, 2-butene, a pentene isomer, 1-hexene, 1-octene, 1-nonene, 1-decene, 1-undecene, 1-dodecene, 4-methyl-1-pentene, 4-methyl-1-hexene, 5-methyl-1-hexene, vinylcyclohexene, and styrene, etc., as comonomers. These comonomers may be included in a content of 1 to 35 wt % based on the total elastomer.

In the present invention, the polyolefin-based elastomer may include a polyene derivative having two or more unsaturated bonds, for example, a straight chain non-cyclic olefin, a branched chain non-cyclic olefin, a single ring alicyclic olefin, a multi-ring alicyclic ring olefin, cycloalkenyl-substituted alkene, etc.

In the present invention, the polyolefin-based elastomer may have a melt index of 2 to 10 g/10 min, and more preferably, 7 to 9 g/10 min, as measured according to ASTM D1238 at 230° C. and 2.16 kg. When the melt index is less than 2 g/10 min, it may be difficult to be processed due to low flowability. When the melt index is more than 10 g/10 min, it may be difficult to mold the film due to low viscosity. In the present invention, the polyolefin-based elastomer may have a tensile strength of 300 to 1800 PSI as measured according to ASTM D638.

In addition, the polyolefin-based elastomer may have a density of 0.850 to 0.895 g/cm³, more preferably 0.860 to 0.890 g/cm³, and the most preferably 0.865 to 0.875 g/cm³ as measured according to ASTM D792. When the density is less than 0.850 g/cm³, the film may be excessively soft, and mechanical strength of the film may be reduced. When the density is more than 0.895 g/cm³, the film may be excessively stiff, and marketability may be deteriorated. In particular, when the density satisfies the range of 0.865 to 0.875 g/cm³, it is preferred since a sealing strength at a low temperature is significantly increased while satisfying the mechanical strength and flexibility of the film.

In addition, the polyolefin-based elastomer according to the present invention may further include at least one elastomer having different structures. Combinations of these various polyolefin-based elastomers are all permissible within a range in which objects of the present invention are not impaired.

In the present invention, the polyolefin-based elastomer may be manufactured by manufacturing methods described in U.S. Pat. No. 7,232,871, No. 6,881,800, etc. However, the present invention is not limited to the specific polymerization methods such as the above-described manufacturing method, and other polymerization methods may be applied.

Preferred polyolefin-based elastomers that are applicable to the present invention may include VISTAMAXX (ExxonMobil Chemical Company), VERSIFY (Dow Chemical Company), TAFMER XM or NOTIO (Mitsui Company), and SOFTELL (Basell Polyolefins), etc.

In the present invention, the polyolefin-based elastomer may be included in a content of 10 to 90 wt %, preferably 30 to 70 wt %, and the most preferably 30 to 60 wt %, based on 100 wt % of the total heat-sealable film composition. When the polyolefin-based elastomer is added in a content of less than 10 wt %, it is not possible to expect an effect of lowering the sealing temperature. When the polyolefin-based elastomer is added in a content of more than 90 wt %, film appearance may be poor due to occurrence of fish-eye, gel, or the like. In particular, when the polyolefin-based elastomer is included in a content of 30 to 60 wt %, it is preferred since it is possible to remarkably increase the sealing property at a low temperature, and to suppress the occurrence of fish eye or gel by addition of polyoxymethylene.

The composition constituting the heat-sealable film in the present invention may further include a polypropylene-based resin.

In the present invention, the polypropylene-based resin is not limited to the type as long as it is used for a sealant, a packaging film, etc. For example, the polypropylene-based resin may be any one selected from the group consisting of general homo polypropylene (general homo PP), high crystal polypropylene copolymer (HCCP homo PP), high crystal block polypropylene copolymer (HCCP block copolymer PP), random copolymer PP, and butyl tertiary polypropylene terpolymer (tert-PP), etc.

In the present invention, the polypropylene-based resin may be included in a content of 10 to 30 wt %, and more preferably 10 to 20 wt %, based on 100 wt % of the total heat-sealable film composition. When the polypropylene-based resin is added in a content of less than 10 wt %, the content thereof is relatively small as compared to that of the polyethylene-based resin, and thus, the lusterless effect of the film may be reduced. When the polypropylene-based resin is added in a content of more than 30 wt %, the content of the polyolefin-based elastomer is relatively small, and thus, a low-temperature sealing performance may be reduced.

Further, when the heat-sealable film composition further includes the polypropylene-based resin, the total composition preferably has a composition ratio of 30 to 60 wt % of the polyethylene-based resin, 10 to 30 wt % of the polypropylene-based resin, and 30 to 60 wt % of the polyolefin-based elastomer. When the composition ratio of the composition is satisfied, it is preferred that a sealing strength at a low temperature is excellent, and the lusterless property is imparted.

In addition, the heat-sealable film according to the present invention may further include an organic peroxide to induce mutual bonding between some of the resins to improve a property of preventing occurrence of defects by increasing dispersibility.

In the present invention, the organic peroxide may be included in the composition forming the heat-sealable film. As an example, the organic peroxide may be any one or two or more selected from the group consisting of hydroperoxide, carboxylic acid peroxyester, peroxyketal, dialkyl peroxide, diacyl peroxide, ketone peroxide, diaryl peroxide, aryl-alkyl peroxide, peroxydicarbonate, peroxyacid, acylalkylsulfonyl peroxide, and monoperoxy dicarbonate.

More preferably, the organic peroxide that is usable in the present invention may be any one or two or more selected from the group consisting of dicumyl peroxide, 2,5-dimethyl-2,5-di-(tert-butylperoxy)hexane, di-tert-butyl peroxide, 2,5-dimethyl-2,5-di-(tert-butylperoxy)hexyne-3,3,6,9-triethyl-3,6,9-trimethyl-1,4,7-triperoxonane, benzoyl peroxide, 2,4-dichlorobenzoyl peroxide, tert-butyl peroxyacetate, tert-butyl peroxybenzoate, tert-amylperoxy-2-ethylhexyl carbonate, tert-butylperoxy-3,5,5-trimethylhexanoate, 2,2-di(tert-butylperoxy)butane, tert-butylperoxy isopropyl carbonate, tert-butylperoxy-2-ethylhexyl carbonate, butyl 4,4-di(tert-butylperoxy) valerate, di-tert-amyl peroxide, tert-butyl peroxy pivalate, tert-butyl-peroxy-2-ethyl hexanoate, di(tert-butylperoxy)cyclohexane, tert-butylperoxy-3,5,5-trimethylhexanoate, di(tert-butylperoxyisopropyl)benzene, cumene hydroperoxide, tert-butyl peroctoate, methyl ethyl ketone peroxide, tert-butyl α-cumyl peroxide, 2,5-dimethyl-2,5-di(peroxybenzoate)hexyne-3, 1,3- or 1,4-bis(t-butylperoxyisopropyl)benzene, lauroyl peroxide, tert-butyl peracetate, and tert-butyl perbenzoate, and the most preferably, 2,5-dimethyl-2,5-di-(tert-butylperoxy)hexane.

In the present invention, the organic peroxide is preferably included in a content of 0.001 to 1 part by weight based on 100 parts by weight of the total heat-sealable film composition. When the organic peroxide is added in a content of less than 0.001 part by weight, since a sufficient radical initiation reaction does not occur, dispersibility between some resins may be deteriorated, and thus, an effect of preventing occurrence of defects may be deteriorated. When the organic peroxide is added in a content of more than 1 part by weight, physical properties of the film may be lowered due to an excessive radical reaction.

The present invention may provide a lusterless film including the heat-sealable film. Further, the present invention may provide a lusterless film including: the heat-sealable film; a center layer formed on one surface of the heat-sealable film and including a polypropylene-based resin; and a skin layer formed on one surface of the center layer and including a polypropylene-based resin.

In the present invention, the center layer may include the polypropylene-based resin. The polypropylene-based resin used in the present invention may be a homo polypropylene or a propylene random copolymer containing a small content, for example, 10 mol % or less, and preferably a content of less than 5 mol % of units derived from olefins other than propylene.

The monomer polymerized with the homo polypropylene in the present invention may be, for example, C2-C20 alphaolefin including ethylene, 1-butene, 1-hexene, 1-heptene, 1-octene, 1-decene, 1-dodecene, 1-hexadecene, 4-methyl-1-pentene, etc.

In the present invention, the polypropylene-based resin is the most preferably homo polypropylene. Since the homo polypropylene has excellent mechanical properties such as heat resistance, bending strength, etc., mechanical properties of the lusterless film may be secured by including the homo polypropylene in the center layer.

In the present invention, the skin layer may be laminated on one surface of the center layer and may include the polypropylene-based resin. Here, the polypropylene-based resin included in the skin layer may include the polypropylene-based resin that is the same as or different from the center layer.

In the present invention, the skin layer is laminated on the other surface of the center layer, that is, a surface facing the heat-sealable film on the basis of the center layer, and may be formed of a composition including a polyethylene-based resin, a polypropylene-based resin, and a polyolefin-based elastomer.

The lusterless film according to the present invention is characterized in that sealing strength at a low temperature is excellent. It may be confirmed by Equations 1 to 4 below:

St₁≧0.003 kgf [Equation 1]

St₂≧0.005 kgf [Equation 2]

St₃≧0.015 kgf [Equation 3]

St₄≧0.12 kgf [Equation 4]

in Equation 1, St₁ means a strength at the moment of peeling when the heat-sealable film is sealed according to KS M ISO 11339, and is pulled in opposite directions at a speed of 200 mm/min at a temperature of 110° C., in Equation 2, St₂ means a strength at the moment of peeling when the heat-sealable film is sealed according to KS M ISO 11339, and is pulled in opposite directions at a speed of 200 mm/min at a temperature of 115° C., in Equation 3, St₃ means a strength at the moment of peeling when the heat-sealable film is sealed according to KS M ISO 11339, and is pulled in opposite directions at a speed of 200 mm/min at a temperature of 120° C., and in Equation 4, St₄ means a strength at the moment of peeling when the heat-sealable film is sealed according to KS M ISO 11339, and is pulled in opposite directions at a speed of 200 mm/min at a temperature of 125° C.

Equations 1 to 4 show sealing strengths at 110° C., 115° C., 120° C., and 125° C., respectively, according to specific measurement standards. By satisfying Equations 1 to 4, the lusterless film manufactured according to the present invention may be subjected to low-heat sealing, and may use less energy as compared to conventional sealing processes requiring a high temperature.

More specifically, the lusterless film according to the present invention may satisfy Equations 5 to 8:

St₁≧0.009 kgf [Equation 5]

St₂≧0.02 kgf [Equation 6]

St₃≧0.12 kgf [Equation 7]

St₄≧0.7 kgf. [Equation 8]

In the present invention, Equations 1 to 8 do not restrict the sealing strength to the upper limit values. This is because when the peel force is increased by a certain amount or more, it is meaningless to limit the upper limit values since the film tears or breaks before the peeling occurs. That is, the upper limit values of the sealing strength in Equations 1 to 8 may be the same as or similar to tear strength or breaking strength of the lusterless film.

In addition, the lusterless film according to the present invention may have a haze value of less than 80%, and more specifically, less than 77%, as measured by a haze measuring device (XL-211).

Further, the lusterless film according to the present invention may have a gloss value of less than 7.5% as measured at 45 degrees by a gloss measuring device (Glossgard II).

A manufacturing method of a lusterless film according to the present invention may include:

a) preparing a center layer composition, a skin layer composition, and a heat-sealable film composition each including a polypropylene-based resin; and

b) co-extruding each of the center layer composition, the skin layer composition, and the heat-sealable film composition in a molten state so that the skin layer is formed on one surface of the center layer and a heat-sealable film is formed on the other side of the center layer, thereby forming the lusterless film in a stack state.

In the present invention, the skin layer composition may be subjected to co-extruding and casting using an extruder, etc., on one surface of the center layer formed in a film form. The heat-sealable film composition may also be subjected to co-extruding and casting using an extruder, etc., which is the same as the skin layer composition. Here, the skin layer and the heat-sealable film may be stacked facing each other on the basis of the center layer.

In addition, biaxial stretching may be performed to improve durability, etc., of the film. Biaxial stretching conditions are not limited to the present invention, and the stretching may be performed in a state of applying heat in consideration of Tg of the composition forming the low-temperature sealing film. In addition, a stretching magnification is not limited to the present invention, and may be freely controlled within a range in which the objects of the present invention are not impaired.

Further, in the heat-sealable film according to the present invention, a thickness of the film may be controlled through a process of forming the skin layer or the stretching process. In the present invention, the thickness of each layer constituting the heat-sealable film is not limited, but may be preferably 1 to 2 μm.

Hereinafter, the present invention is described in more detail with reference to Examples and Comparative Examples. Meanwhile, Examples and Comparative Examples are provided by way of example for explaining the present invention in more detail, and therefore, the present invention is not limited thereto.

Physical properties of respective specimens manufactured by Examples and Comparative Examples were measured as follows.

(Sealing Property)

The same specimens manufactured in Examples and Comparative Examples were subjected to thermo-compression at respective temperature conditions, and then strength (sealing strength) at the moment of peeling when the respective compressed films were pulled in opposite directions at a speed of 200 mm/min was measured by using a high rigidity universal testing machine (UTM). Here, o indicated that the film was completely thermo-compressed in a partial region, and peeled only in the partial region, and ⊚ indicated that the film was completely thermo-compressed in all regions and not peeled at all.

(Haze)

Haze values of five points in a unit area (600 cm²) of the specimens were measured using a haze measuring device (XL-211 manufactured by Pacific Scientific), and an average value was calculated.

(Gloss)

Gloss values of five points in a unit area (600 cm²) of the specimens were measured using a gloss measuring device (Glossgard II manufactured by Pacific Scientific), and an average value was calculated.

(Surface State)

When the number of fish-eye and gel observed with the naked eye in the unit area (600 cm²) of the specimen was 3 or less, it was determined as good. When the number of fish-eye and gel observed with the naked eye in the unit area (600 cm²) of the specimen was more than 3, it was determined as defective.

### Example 1

A film was manufactured by preparing a heat-sealable film composition including 50 wt % of polyethylene (PE, PD800F, SK General Chemicals), 40 wt % of tert-polypropylene (PP, SFC750, Lotte Chemical), and 10 wt % of a polyolefin-based elastomer (POE, Versify 3000, Dow chemical), followed by extrusion to have a thickness of 30 μm. Set temperatures of an extruder were 190° C. (hopper), 220° C. (barrel), and 225° C. (die), respectively. Physical properties of the manufactured film were measured, and shown in Tables 2 to 3 below.

### Examples 2 to 10

Each film was manufactured in the same manner as in Example 1, except that the composition ratio of the heat-sealable film composition was changed as shown in Table 1 below. Physical properties of the manufactured film were measured, and shown in Tables 2 and 3 below.

### Comparative Example 1

A film was manufactured in the same manner as in Example 1, except that the heat-sealable film composition was prepared by mixing 50 wt % of polyethylene (PD800F, SK General Chemicals) and 50 wt % of tert-polypropylene (SFC750, Lotte Chemical). Physical properties of the manufactured film were measured, and shown in Tables 2 to 3 below.

TABLE 1

| | PE (wt %) | PP (wt %) | POE (wt %) | Note |
|---|---|---|---|---|
| Example 1 | 50 | 40 | 10 | Versify3000 |
| Example 2 | 50 | 30 | 20 | |
| Example 3 | 50 | 20 | 30 | |
| Example 4 | 50 | 10 | 40 | |
| Example 5 | 50 | — | 50 | |
| Example 6 | 50 | 40 | 10 | Versify3300 |
| Example 7 | 50 | 30 | 20 | |
| Example 8 | 50 | 20 | 30 | |
| Example 9 | 50 | 10 | 40 | |
| Example 10 | 50 | — | 50 | |
| Comparative | 50 | 50 | — | — |
| Example 1 | | | | |

TABLE 2

| | Sealing strength (kgf) according to thermo- | | | | |
|---|---|---|---|---|---|
| | compression temperature | | | | |
| | 110° C. | 115° C. | 120° C. | 125° C. | 130° C. |
| Example 1 | 0.0030 | 0.0062 | 0.0154 | 0.1403 | 1.0253 |
| Example 2 | 0.0060 | 0.0113 | 0.0483 | 0.2960 | ◯ |
| Example 3 | 0.0095 | 0.0214 | 0.1301 | 0.7620 | ◯ |
| Example 4 | 0.0175 | 0.0827 | 0.5608 | ◯ | ⊚ |
| Example 5 | 0.0141 | 0.3880 | ◯ | ⊚ | ⊚ |
| Example 6 | 0.0141 | 0.0188 | 0.0375 | 0.1792 | 0.7365 |
| Example 7 | 0.0224 | 0.0365 | 0.1538 | 0.5338 | ◯ |
| Example 8 | 0.0621 | 0.1432 | 0.4231 | 0.8670 | ⊚ |
| Example 9 | 0.1620 | 0.3069 | 0.8036 | ⊚ | ⊚ |
| Example 10 | ⊚ | ⊚ | ⊚ | ⊚ | ⊚ |
| Comparative | 0 | 0.0011 | 0.0030 | 0.0212 | 0.3580 |
| Example 1 | | | | | |

TABLE 3

| | Haze | Gloss | |
|---|---|---|---|
| | (%) | (%, 45°) | Surface state |
| Example 1 | 73.93 | 7.2 | Good |
| Example 2 | 74.11 | 7.3 | Good |
| Example 3 | 75.53 | 7.0 | Good |
| Example 4 | 76.42 | 6.9 | Defective |
| Example 5 | 76.54 | 6.5 | Defective |
| Example 6 | 74.52 | 7.0 | Good |
| Example 7 | 76.04 | 6.3 | Good |
| Example 8 | 76.42 | 6.2 | Good |
| Example 9 | 76.74 | 6.1 | Defective |
| Example 10 | 77.64 | 5.9 | Defective |
| Comparative | 74.92 | 6.8 | Good |
| Example 1 | | | |

As shown in Tables 2 and 3, it was confirmed that all of Examples 1 to 10 in which the polyolefin-based elastomer was added could be subjected to sealing at a lower temperature than that of Comparative Example. However, it could be appreciated that when the polyolefin-based elastomer was added in a content of 40 wt % or more based on 100 wt % of the total heat-sealable film composition (Examples 4, 5, 9, and 10), fish-eye, gel, etc., were found on a surface of the film, and thus, a film state was not good.

In addition, it could be appreciated that the haze and gloss thereof were not significantly different from those of the conventional specimens regardless of the added amount of the polyolefin-based elastomer. However, it could be confirmed that as the content of the polyolefin-based elastomer was increased, the haze was increased and the gloss was gradually decreased.

### Example 11

A film was manufactured in the same manner as Example 1, except that a heat-sealable film composition included 50 wt % of polyethylene (PE, PD800F, SK General Chemicals), 40 wt % of tert-polypropylene (PP, SFC750, Lotte Chemical), and 10 wt % of a polyolefin-based elastomer (POE, Versify 3300, Dow chemical), and 0.01 parts of organic peroxide (Luperox 101, Sigma Aldrich) was further included in 100 parts by weight of the heat-sealable film composition. Physical properties of the manufactured film were measured, and shown in Tables 4 to 5 below.

### Examples 12 and 13

The film was manufactured in the same manner as Example 11, except that the content of the polyolefin-based elastomer was changed as shown in Table 4 below. Physical properties of the manufactured film were measured and shown in Tables 4 to 5 below.

### Comparative Example 2

A film was manufactured in the same manner as in Comparative Example 1, except that 0.01 parts by weight of the organic peroxide of Example 11 was added to 100 parts by weight of the heat-sealable film composition of Comparative Example 1. Physical properties of the manufactured film were measured and shown in Tables 4 to 5 below.

TABLE 4

| | Sealing strength (kgf) according to | | | | | |
|---|---|---|---|---|---|---|
| | thermo-compression temperature | | | | | |
| | 110° C. | 115° C. | 120° C. | 125° C. | 130° C. | Note |
| Example 11 | 0.0035 | 0.0069 | 0.0207 | 0.1394 | ◯ | Versify3300 |
| | | | | | | 10 wt % |
| Example 12 | 0.0138 | 0.0396 | 0.1697 | 0.4970 | ⊚ | Versify3300 |
| | | | | | | 20 wt % |
| Example 13 | 0.0249 | 0.0791 | 0.2801 | 0.6195 | ⊚ | Versify3300 |
| | | | | | | 25 wt % |
| Comparative | 0.0019 | 0.0027 | 0.0073 | 0.0519 | 0.3569 | — |
| Example 2 | | | | | | |

TABLE 5

| | Haze | Gloss | Surface | |
|---|---|---|---|---|
| | (%) | (%, 45°) | state | Note |
| Example 11 | 85.92 | 3.9 | Good | Versify3300 10 wt % |
| Example 12 | 86.18 | 3.7 | Good | Versify3300 20 wt % |
| Example 13 | 86.31 | 3.7 | Good | Versify3300 25 wt % |
| Comparative | 87.03 | 3.6 | Good | — |
| Example 2 | | | | |

As shown in Table 4, it was confirmed that all of Examples 11 to 13 in which the polyolefin-based elastomer was added could be subjected to sealing at a lower temperature than that of Comparative Example. Accordingly, it could be confirmed that as the content of the polyolefin-based elastomer was increased, a sealing degree became better regardless of the addition of the organic peroxide.

As shown in Table 5, it could be appreciated that the specimens of Examples 11 to 13 were not significantly different in the haze and gloss as compared to those of Comparative Example, i.e., the conventional specimen. In addition, it could be confirmed that the specimens of Examples 11 to 13 had increased haze values and decreased gloss values as compared to those of Examples 1 to 10.

The heat-sealable film according to the present invention may be obtained by mixing the polyethylene-based resin and the polyolefin-based elastomer, wherein the polyolefin-based elastomer satisfies specific density, specific tensile strength and specific melt index, and thus, it is possible to implement excellent physical properties such as lower low-temperature sealing property, higher surface hardness, and suppression of defect occurrence, etc., as compared to conventional heat-sealable films.

The lusterless film having the low temperature sealing property according to the present invention is able to satisfy all the mechanical properties required for conventional packaging films and protective films while having excellent lusterless property by using the heat-sealable film.

Further, the lusterless film having the low-temperature sealing property according to the present invention may be thermally adhered to the surface of the substrate such as papers and metals based on the above-described property, thereby being used not only as films for surface protection such as book covers, calendars, shopping bags, posters, structures, etc., but also as films for various packaging, and thus, it is possible to minimize the process loss and reduce the cost.

What is claimed is:

1. A heat-sealable film comprising:
10 to 90 wt % of a polyethylene-based resin; and
10 to 90 wt % of a polyolefin-based elastomer.

2. The heat-sealable film of claim 1, comprising: 30 to 70 wt % of the polyethylene-based resin and 30 to 70 wt % of the polyolefin-based elastomer.

3. The heat-sealable film of claim 1, further comprising a polypropylene-based resin.

4. The heat-sealable film of claim 3, comprising: 30 to 60 wt % of the polyethylene-based resin, 10 to 30 wt % of the polypropylene-based resin, and 30 to 60 wt % of the polyolefin-based elastomer.

5. The heat-sealable film of claim 1, wherein the polyolefin-based elastomer has a density of 0.850 to 0.895 g/cm³ as measured according to ASTM D792, a tensile strength of 300 to 1800 PSI as measured according to ASTM D638, and a melt index of 5 to 10 dg/min as measured according to ASTM D1238 at 230° C. and 2.16 kg.

6. The heat-sealable film of claim 5, wherein the polyolefin-based elastomer has a density of 0.865 to 0.875 g/cm³ as measured according to ASTM D792.

7. The heat-sealable film of claim 1, wherein the polyolefin-based elastomer is a copolymer or a terpolymer in which propylene and at least any one monomer selected from the group consisting of ethylene, 1-butene, 2-butene, a pentene isomer, 1-hexene, 1-octene, 1-nonene, 1-decene, 1-undecene, 1-dodecene, 4-methyl-1-pentene, 4-methyl-1-hexene, 5-methyl-1-hexene, vinylcyclohexene, and styrene, are copolymerized.

8. The heat-sealable film of claim 1, further comprising:
at least any one organic peroxide selected from the group consisting of hydroperoxide, carboxylic acid peroxyester, peroxyketal, dialkyl peroxide, diacyl peroxide, ketone peroxide, diaryl peroxide, aryl-alkyl peroxide, peroxydicarbonate, peroxyacid, acylalkylsulfonyl peroxide, and monoperoxy dicarbonate.

9. A lusterless film comprising:
the heat-sealable film of claim 1;
a center layer formed on one surface of the heat-sealable film and including a polypropylene-based resin; and
a skin layer formed on one surface of the center layer and including a polypropylene-based resin.

10. The lusterless film of claim 9, satisfying Equations 1 to 4 below:
St₁≧0.003 kgf [Equation 1]
St₂≧0.005 kgf [Equation 2]
St₃≧0.015 kgf [Equation 3]
St₄≧0.12 kgf [Equation 4]
in Equation 1, St₁ means a strength at the moment of peeling when the heat-sealable film is sealed according to KS M ISO 11339, and is pulled in opposite directions at a speed of 200 mm/min at a temperature of 110° C., in Equation 2, St₂ means a strength at the moment of peeling when the heat-sealable film is sealed according to KS M ISO 11339, and is pulled in opposite directions at a speed of 200 mm/min at a temperature of 115° C., in Equation 3, St₃ means a strength at the moment of peeling when the heat-sealable film is sealed according to KS M ISO 11339, and is pulled in opposite directions at a speed of 200 mm/min at a temperature of 120° C., and in Equation 4, St₄ means a strength at the moment of peeling when the heat-sealable film is sealed according to KS M ISO 11339, and is pulled in opposite directions at a speed of 200 mm/min at a temperature of 125° C.

11. The lusterless film of claim 10, satisfying Equations 5 to 8 below:
St₁≧0.009 kgf [Equation 5]
St₂≧0.02 kgf [Equation 6]
St₃≧0.12 kgf [Equation 7]
St₄≧0.7 kgf. [Equation 8]

12. The lusterless film of claim 9, having a haze value of less than 80% as measured by a haze measuring device (XL-211).

13. The lusterless film of claim 9, having a gloss value of less than 7.5% as measured at 45 degrees by a gloss measuring device (Glossgard II).
